(19) United States
(12) Patent Application Publication
(10) Pub. No.: US 2024/0001270 A1
(43) Pub. Date: Jan. 4, 2024

(54) SELF-DECONTAMINATING NANOFIBROUS FILTERS

(71) Applicant: VIRGINIA COMMONWEALTH UNIVERSITY, Richmond, VA (US)

(72) Inventors: Weining Wang, Glen Allen, VA (US); Zan Zhu, Richmond, VA (US); Ping Xu, Henrico, VA (US)

(21) Appl. No.: 18/251,585

(22) PCT Filed: Oct. 25, 2021
(86) PCT No.: PCT/US2021/056434

§ 371 Date: May 3, 2023

Related U.S. Application Data
(60) Provisional application No. 63/108,941, filed on Nov. 3, 2020.

(51) Int. Cl. B01D 39/16; A01N 33/12; A01P 1/00; A01N 25/08; B01D 39/20

(52) U.S. Cl. CPC B01D 39/1623; A01N 33/12; A01P 1/00; A01N 25/08; B01D 39/2027; B01D 2239/0478; B01D 2239/0631; B01D 2239/1225

(57) ABSTRACT

A filter having antibacterial activity is provided. The filter comprises at least one layer of polymer nanofibers and antibacterial particles positioned on or within the at least one layer of polymer nanofibers, wherein the antibacterial particles comprise a quaternary ammonium compound grafted onto a surface of a metal-organic framework. Methods of manufacturing the filter and decontaminating a fluid are also provided.

### FIELD OF THE INVENTION

The invention is generally related to an electrospun filter having antibacterial activity. In particular, the filter includes metal-organic framework (MOF) particles modified with quaternary ammonium compounds coated on the surface of polymer nanofibers.

### BACKGROUND OF THE INVENTION

Hospital-acquired infections (HAIs), also known as health-associated infections, have been recognized as a major threat to the safety of patients and healthcare workers worldwide.[1-5] During the COVID-19 pandemic, numerous cross-infections occurred in the hospitals among healthcare workers and patients, indicating that the adverse effects of HAIs such as mortality, morbidity, and associated costs are enormous.[6] To reduce the HAIs, face-piece respirators such as N95 respirators and surgical masks are recommended by the United States Centers for Disease Control and Prevention (CDC) as efficient respiratory personal protective equipment (PPE).[7-9] For convenience, the term ‘face mask’ is used to represent N95 respirators and surgical masks as described herein. Even though the commercial face masks can provide users with a certain degree of protection, there are still intensive research efforts to improve their performance in terms of particulate matter (PM) filtration, user-friendliness, and airborne pathogens inactivation.[10-12]

Electrospinning producing nanofibers from a polymer solution is an efficient technique to fabricate filter media with high PM filtration performance, attributing to the small diameters of the nanofibers and fiber charges.[13-17] To further increase the functionality, e.g., hydrophobicity, breathability, toxic gas removal, etc., of the electrospun filters, metal-organic frameworks (MOFs), a class of porous crystalline polymers, have been embedded into the electrospun polymer to form the MOF-based filters.[18-23] Endorsed by the hierarchical structures and tunable surface chemistry, the MOF-based nanofiber filters not only possess different functionalities but also achieve a high PM filtration efficiency and a lower pressure drop [18, 24] which is beneficial to the wearer's comfort in breathing. However, most of these MOF-based filters cannot be used to actively kill microorganisms such as bacteria. To impart the antibacterial properties to the MOF-based filters, the key is to develop a fabrication method for filters with high efficiency for the simultaneous removal of PM and inactivation of bacteria.

Bacteria pathogens are one of the major infectious agents that cause the persistence of HAIs. [25] Indirect contact with contaminated surfaces and airborne droplets are two of the most common modes of bacteria transmission.[26] Most commercial face masks and electrospun MOF-based filters can only passively block the transmission of airborne bacteria but not be able to kill them in-situ, i.e., on the mask surface. The bacteria being captured by the face mask may accumulate on the mask surface and can still survive for hours or even days, which would significantly increase the possibility of HAIs through surface contact transmission.[27, 28] Therefore, there is an urgent demand to develop antibacterial filters for face masks. This need can be achieved by incorporating antibacterial materials into face mask filters. Conventional strategies of using antibacterial agents such as Ag ions, Cu ions, metal oxides,[31], and photosentisizers[32] are not very suitable because most of these materials are toxic to humans and environmentally unfriendly. In particular, when people breathe, talk, cough, or sneeze, the water droplets may condense on the mask surface,[33] which might cause the release of these chemicals. As a result, a safer method is demanded to impart the face mask with nonleaking and antibacterial properties.

Quaternary ammonium compounds (QACs) are potent antimicrobials that are widely used as disinfectants because of their low toxicity, the flexibility of molecule structures, the readiness of fixation on the surface, the low probability of antibiotic resistance, and so on.[35-38] The bactericidal activity of QACs stems from the electrostatic attraction between permanent positively charged nitrogen (NT⁺) in QACs and negatively charged bacterial membrane,[39] which would ultimately lead to cell lysis, namely the burst of cytoplasmic material.[40] In particular, the polymeric QACs with long alkyl chains exhibited enhanced

bactericidal activity because the longer alky chains can interact with the lipid cell walls more strongly and destabilize the bacterial membrane more effectively.[41] Even though the recent emerging popular “grafting from” approach, also known as “surface-initiated polymerization”, has enabled the controllable grafting QACs on the material surfaces, the immobilization of polymeric QACs onto filters is still challenging for the following reasons.

Firstly, the surface of the filter should be pretreated by plasma or other chemical treatment to allow the fixation of the suitable initiators, which is complicated and time-consuming Secondly, the harsh organic solvents would impair the PM filtration efficiency of electret media, which is one of the most important functionalities of the face mask filter. [17, 43, 44] Therefore, how to immobilize the polymeric QACs on the face mask filters without compromising the PM filtration efficiency is a prominent quest.

### SUMMARY

Described herein is the incorporation of a QAC-modified MOF into electrospun fibers to form an active composite filter.

An aspect of the disclosure provides a filter comprising at least one layer of polymer nanofibers and antibacterial particles positioned on or within the at least one layer of polymer nanofibers, wherein the antibacterial particles comprise a QAC such as poly [2-(dimethyl decyl ammonium) ethyl methacrylate] (PQDMAEMA) grafted onto a surface of a MOF.

In some embodiments, the at least one layer of polymer nanofibers comprises polyacrylonitrile (PAN) nanofibers. In some embodiments, the metal-organic framework is a water-stable MOF. Typical examples include but are not limited to zirconium-based, titanium-based, or aluminum-based MOFs. In some embodiments, the filter further comprises graphitic carbon nitride (g-C₃N₄) arranged on a surface of the MOF. In some embodiments, the antibacterial particles constitute 55-65 wt % of the filter. In some embodiments, the antibacterial particles have a larger diameter than the polymer nanofibers. In some embodiments, the antibacterial particles have an average diameter of 200-250 nm. In some embodiments, the polymer nanofibers have an average diameter of 100-150 nm. In some embodiments, the antibacterial particles are positioned on a surface of the polymer nanofibers.

Another aspect of the disclosure provides a face mask wearable by a subject comprising a filter as described herein.

Another aspect of the disclosure provides a method for decontaminating a fluid comprising bringing the fluid in contact with a filter as described herein. In some embodiments, the fluid is or comprises air. In some embodiments, the fluid is or comprises water. In some embodiments, the filter is incorporated within a face mask wearable by a subject. In some embodiments, the filter is incorporated within a heating, ventilation, and air conditioning (HVAC) system.

Another aspect of the disclosure provides a method of manufacturing a filter as described herein comprising electrospinning a polymer solution comprising the antibacterial particles onto a collector. In some embodiments, the electrospinning step is performed at a temperature of 45-55° C. In some embodiments, the electrospinning step is performed at a relative humidity of 5-15%. In some embodiments, the electrospinning step is performed at a voltage of 15-20 kV. In some embodiments, the polymer solution contains polyacrylonitrile (PAN). In some embodiments, the polymer solution contains 55-65 wt % antibacterial particles.

### BRIEF DESCRIPTION OF THE DRAWINGS

FIG. 1. Schematic illustration of UiO-PQDMAEMA@PAN filter towards PM capture and airborne bacteria inactivation.

FIG. 2. Schematic preparation route for UiO-PQDMAEMA.

FIGS. 3A-B. Schematic diagram of the experimental setup for (A) particle filtration measurements and (B) bacteria filtration tests.

FIGS. 4A-I. FT-IR spectra (A) and XRD patterns (B), high-resolution N is XPS spectra (C), SEM images (D, E, F), and TEM images (G, H, I) of UiO-66-NH₂, and UiO-PQDMAEMA, respectively (top to bottom). Scale bars in (D-F): 500 nm; Scale bars in (G-I): 50 nm.

FIGS. 5A-F. SEM images, fiber diameter distribution, and BET analysis of pure PAN filter (A, C, E, F) and UiO-PQDMAEMA@ PAN filter (B, D, E, F).

FIGS. 6A-D. Digital images of as-synthesized UiO-PQDMAEMA@PAN filter (A) and commercial N95 respirator (B); Inset image is a relatively flat sheet cut out from the commercial N95 respirator for particle filtration test; Particle filtration efficiency (C) and quality factor (D) tested by NaCl particles of 20-500 nm at a face velocity at 9.3 cm/s towards pure PAN filter, UiO-PQDMAEMA@PAN filter, and commercial N95 respirator.

FIGS. 7A-B. Collected S. epidermidis (A) and E. coli (B) concentration in the SKC BioSampler after the airborne bacteria passing through the UiO-PQDMAEMA@PAN filter and commercial N95 respirator.

FIGS. 8A-B. S. epidermidis (A) and E. coli. (B) inactivation performance towards commercial N95 respirator filter, PAN, UiO-66-NH₂@PAN, and UiO-PQDMAEMA@PAN filter.

FIGS. 9A-D. SEM images of UiO-PQDMAEMA@PAN filter with S. epidermidis (A, B) and E. coli. (C, D) after contacting treatment for 0 and 2 hours.

FIG. 10. Schematic preparation route for g-C₃N₄@MIL-125-QAC.

FIGS. 11A-B. S. epidermidis (A) and E. coli. (B) inactivation performance after contact with C-M or C-M-Q.

FIG. 12. Graph of the concentration of toluene upstream and downstream as determined by gas chromatography (GC).

### DETAILED DESCRIPTION

Embodiments of the disclosure provide nanofibrous filters having antibacterial activity.

In particular, a layer of polymeric quaternary ammonium compounds (QAC) is added to a metal-organic framework (MOF) through a classical atomic transfer radical polymerization (ATRP) approach. Utilizing an electrospinning technique, the as-synthesized active composite MOF-QAC may be embedded with a polymer solution to produce an antibacterial nanofibrous filter, which also exhibits a high PM filtration performance comparable to a commercial N95 respirator. The filters described herein are capable of efficiently killing both Gram-positive and Gram-negative bacteria by destroying their cell membranes. The antibacterial filters may be incorporated into face masks or used for the fabrication of heating, ventilation, and air conditioning (HVAC) air filters or for waterborne bacteria disinfection.

Quaternary ammonium compounds (commonly known as quats or QACs) are positively charged polyatomic ions of the structure NR⁺₄, R being an alkyl group or an aryl group. QACs are cationic surfactants (surface active agents) that combine bactericidal and virucidal activity. Examples include poly [2-(dimethyl decyl ammonium)ethyl methacrylate] (PQDMAEMA), hexadecyltrimethylammonium (‘cetrimide’), chlorhexidine, benzalkonium chloride, poly[2-tert-Butylamino ethyl methacrylate] (PTBAEMA), and poly(3-(trimethoxysilyl)propyl methacrylate) (PTMSPMA). Given that their primary mechanism of action is the structure/function disruption against cell membranes, they generally demonstrate bactericidal and fungicidal activity, with further activity observed against enveloped viruses. QACs are also potent microstatic (including sporistatic) agents. Being positively charged, they are rapidly attracted to the cell wall surface, with initial surface structure disruption, penetration to the cell membrane, and direct insertion to and interaction with the phospholipids, leading to structure/function disruption (including leakage of cytoplasmic components); these effects culminate in cell death and loss of viability of enveloped viruses.

Conventional QAC monomers are easily dissolved in water which would cause safety concerns to users of a face mask incorporating a filter as described herein when exhaled moisture condenses on the surface of the material. Thus, embodiments of the disclosure provide for the use of polymeric QAC which is grafted on the MOF crystals via covalent bonding which maintains the antimicrobial activity of QAC without causing leaking issues.

Metal-organic frameworks (MOFs) are a class of compounds composed of metal ions or clusters coordinated to organic ligands to form one-, two-, or three-dimensional structures. They are a subclass of coordination polymers, with the special feature that they are often porous. In some embodiments, the MOF is a water-stable MOF which generally has strong coordination bonds or great steric hindrance to prevent hydrolysis reactions (e.g. see [82]). In some embodiments, the MOF comprises an amine group. The amino-derived MOFs provide a great platform to covalently attach functional groups by post-synthetic modification. Exemplary MOFs include a zirconium-based MOF (e.g. UiO-66-NH₂ also known as 2-aminoterephthalate; oxygen(2−); zirconium(4+); tetrahydroxide), a titanium-based MOF (e.g. MIL-125-NH₂ also known as 2-aminoterephthalate; oxygen(2−); titanium; titanium (4+); tetrahydroxide), Aluminum-based MOF (e.g., MIL-53-NH₂, also known as 2-aminoterephthalate; oxygen(2−); aluminum; aluminum(3+); dihydroxide) among others.

The antibacterial particles (QAC-modified MOF) may further comprise additional antibacterial agents such as a graphitic carbon nitride (g-C₃N₄) arranged on a surface of the MOF. Graphitic carbon nitride (g-C₃N₄) is a family of carbon nitride compounds with a general formula near to C₃N₄ (albeit typically with non-zero amounts of hydrogen) and two major substructures based on heptazine and poly(triazine imide) units. Graphitic carbon nitride can be made by polymerization of cyanamide, dicyandiamide or melamine

Embodiments of the disclosure further provide methods of manufacturing a filter as described herein. The antibacterial particles are added to a fiber-forming polymer which is electrospun into a filter having at least one layer of polymer nanofibers where the antibacterial particles are positioned on or within the at least one layer of polymer nanofibers. Electrospinning is a method to produce ultrafine (in nanometers) fibers by charging and ejecting a polymer melt or solution through a spinneret under a high-voltage electric field and to solidify or coagulate it to form a filament.

Suitable polymers include, but are not limited to: both organic and inorganic polymers such as polyacrylonitrile (PAN), polyvinylpyrrolidone (PVP), polycaprolactone (PCL), poly-alpha-hydroxyesters, e.g., poly-lactic-glycolic acid (PLGA), poly-lactic acid (PLA), poly-glycolic acid (PGA), other aliphatic polyesters such as glycol-type polyesters of dibasic aliphatic diacids, aromatic polyesters such as glycol-type polyesters of dibasic aromatic acids (terephthalate, etc.) polyvinyl alcohol (PVA), polyethylene oxide (PEO), or polyolefins such as polyethylene, polypropylene, polyethylene/polypropylene copolymers, polystyrene (PS), and the like; or the fiber-forming substances can be natural materials such as cellulose, chitosan, alginate, gelatin, and the like; or mixtures or blends thereof.

According to an exemplary method of preparation, a solution comprising the polymer and the antibacterial particles can be delivered at a constant rate via a syringe pump; through a syringe fitted with a stainless steel blunt tip needle. The needle is charged through a high voltage supply, and the resulting polymer fibers are collected on a grounded target to form a fibrous mat having antimicrobial properties.

It will be appreciated that careful selection of the carrier polymer and electrospinning conditions allow for the control and selection of various characteristics of the mat produced including, for example, the thickness, size, and composition. In some embodiments, the electrospinning step is performed at a temperature of about 40-60° C., e.g. about 45-55° C. In some embodiments, the electrospinning step is performed at a relative humidity of about 5-20%, e.g. about 5-15%. In some embodiments, the electrospinning step is performed at a voltage of about 10-25 kV, e.g. about 15-20 kV. In some embodiments, the antibacterial particles constitute about 50-70 wt%, e.g. about 55-65 wt % of the electrospun filter.

Multi-layer mats may be produced with each layer having the same or different physical properties (i.e. thickness, porosity, etc.) and/or the same or different antimicrobial particles. The layers may be electrospun separately and then combined, or a subsequent layer or layers may be electrospun directly onto a first layer.

In some embodiments, the antibacterial particles are exposed on the surface of the polymer fibers. However, selective coating of the antibacterial particles on the nanofiber surface by using a single-step electrospinning method can be challenging. Therefore, in some embodiments, the antibacterial particles are configured to have a larger diameter than the polymer nanofibers. In some embodiments, the antibacterial particles have an average diameter of about 175-275 nm, e.g. about 200-250 nm. In some embodiments, the polymer nanofibers have an average diameter of about 75-175 nm, e.g. about 100-150 nm.

Embodiments of the disclosure also provide a face mask incorporating a filter as described herein. Suitable masks and respirators (herein referred to collectively as “face masks” or “masks”) are known in the art. Masks contemplated within the scope of the present disclosure include both disposable and non-disposable masks and include masks that can be reused and washed. A face mask of the disclosure includes those that cover a wearer's nose and/or mouth, and even preferably, a portion of the wearer's face, i.e., cheeks, jaw, chin, and so forth. In one embodiment, a mask/respirator is an N-95, N-99, N-100, R-95, R-99, R-100, P-95, P-99, or P-100 respirator. Suitable masks may also include a bendable metal reinforcement nose bar to allow custom fitting of the mask around the nose of a wearer. Suitable masks may utilize ear loops or may have straps that are configured to wrap around a wearer's head. In some embodiments, the QAC-modified MOF filter forms the entirety of the face-covering portion of the face mask without any additional layers. In some embodiments, the QAC-modified MOF filter is arranged on top (on an outer surface) of a conventional mask. In further embodiments, the QAC-modified MOF filter is arranged between two support protection layers, such as spun-bond polypropylene (PP) fabric.

A filter as described herein may have a shape and size such that it is configured to be inserted into the filter pocket of a commercially available face mask. For example, the filter may be square or rectangular in shape. The filter may have a length or width of about 5-15 cm. Each individual layer of the filter may have a thickness of 10-50 μm. The fibers are nonwoven. The density of the fiber materials (p) is 0.2-0.6 g/cm³. The packing density (a) of the filter is 0.01-0.1. The packing density is the ratio of the volume of the fibers to the volume of the fibrous media.

As set forth in the Examples, the antibacterial particles may be introduced as fillers in the electrospun nanofibers which enables the face mask to have an enhanced surface area and hierarchical pore size distribution. The filter embedding the QAC-modified MOF crystals has a high particle filtration efficiency (>95%) with satisfactory pressure drop, which ensures comfort during breathing.

Further embodiments of the disclosure provide a method for decontaminating a fluid comprising bringing the fluid in contact with a filter as described herein. In some embodiments, the fluid is or comprises air or water. In some embodiments, the filter is incorporated within a heating, ventilation, and air conditioning (HVAC) system. The filter has antibacterial activity against both Gram-positive (e.g. Streptococcus, Staphylococcus, Corynebacterium, Listeria, Bacillus, Clostridium, etc.) and Gram-negative bacteria (e.g. Escherichia coli, Salmonella, Shigella, and other Enterobacteriaceae, Pseudomonas, Moraxella, Helicobacter, Stenotrophomonas, Bdellovibrio, acetic acid bacteria, Legionella, etc. and more specifically Klebsiella pneumoniae, Legionella pneumophila, Pseudomonas aeruginosa, Acinetobacter baumannii, etc.). The filter may also adsorb toxic gas molecules such as volatile organic compounds (VOCs), e.g. toluene, benzene, and styrene which may emit from tobacco smoke, traffic exposure, solvents, and other environmental sources.

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

### EXAMPLE 1

### Summary

With the increased bacteria-induced hospital-acquired infections (HAIs) caused by bio-contaminated surfaces, the requirement for a safer and more efficient antibacterial strategy in designing personal protective equipment (PPE) such as N95 respirators is rising with urgency. Herein, a self-decontaminating nanofibrous filter with a high particulate matter (PM) filtration efficiency was designed and fabricated via a facile electrospinning method. The fillers implemented in the electrospun nanofibers were constructed by grafting a layer of antibacterial polymeric quaternary ammonium compound (QAC), that is, poly [2-(dimethyl decyl ammonium)ethyl methacrylate] (PQDMAEMA), onto the surface of metal-organic framework (MOF, UiO-66-NH₂ as a model) to form the active composite UiO-PQDMAEMA. The UiO-PQDMAEMA filter demonstrates an excellent PM filtration efficiency (>95%) at the most penetrating particle size (MPPS) of 80 nm, which is comparable to that of the commercial N95 respirators. Besides, the UiO-PQDMAEMA filter is capable of efficiently killing both Gram-positive (S. epidermidis) and Gram-negative (E. coli) airborne bacteria. The strong electrostatic interactions between the anionic cell wall of the bacteria and positively charged nitrogen of UiO-PQDMAEMA are the main reasons for severe cell membrane disruption, which leads to the death of bacteria. The present work provides a new avenue for combating air contamination by using the QAC-modified MOF-based active filters.

### Materials and Methods

### Preparation of UiO-66-NH₂, UiO-BIBB, and UiO-PQDMAEMA

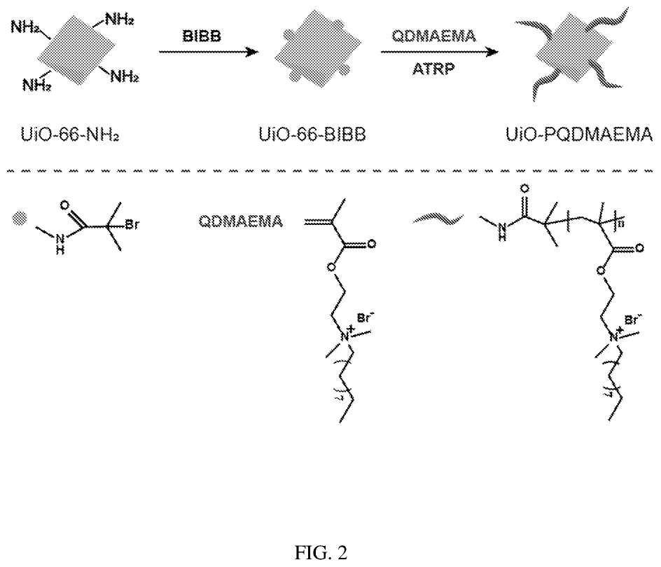

The synthetic procedures for UiO-PQDMAEMA preparation are schematically depicted in FIG. 2. In general, the raw UiO-66-NH₂ was first decorated with initiator 2-bromoisobutyryl bromide (BIBB) via covalent bonding to form UiO-66-BIBB. Then, the monomer 2-(dimethyl decyl ammonium) ethyl methacrylate (QDMAEMA) was polymerized and grafted on the surface of UiO-66-BIBB through the ATRP process to obtain the final product, which is denoted as UiO-PQDMAEMA. The details of material synthesis processes are provided below.

### Preparation of UiO-66-NH₂

Typically, a mixture of 0.2332 g ZrCl₄, 0.1812g BDC-NH₂, and 6 ml acetic acid were dissolved in 50 ml DMF by ultrasonication for 5 minutes. Subsequently, the above mixture was transferred into a 100 ml Teflon-lined stainless-steel autoclave, which was kept at 120° C. for 24 hours. The obtained precipitates were washed thoroughly by DMF and methanol several times. The activation was conducted by immersing the above particles in 50 ml methanol for 72 hours. Finally, the pale-yellow particles were dried at 100° C. under vacuum for 12 hours.

### Preparation of UiO-66-BIBB

The UiO-66-BIBB was obtained by functionalizing UiO-66-NH₂ under the protection of nitrogen in a 50 ml flask. In a typical procedure, 0.3 g UiO-66-NH₂ was suspended in 20 ml anhydrous THF by sonication. 418 μL TEA and 124 μL BiBB were dissolved in 10 ml THF separately. The TEA solution was injected into the UiO-66-NH₂ suspension under stirring. Then the BIBB solution was dropwise added into the mixture in 30 minutes with ice water cooling and strong stirring. The reactants were subsequently sealed and stirred at 50° C. for 24 hours. Finally, the particles were washed with THF and methanol and dried under vacuum at 40° C. The obtained products were named UiO-66-BIBB.

### Preparation of UiO-PQDMAEMA

Poly [2(dimethyl decyl ammonium) ethyl methacrylate] (PQDMAEMA) brushes were prepared by ATRP of QDMAEMA from UiO-66-BIBB. To prepare QDMAEMA, 2.68 ml DMAEMA and 3.9 ml of 1-bromodecane were added into 10 ml acetonitrile in a 50 ml flask and reacted for 24 hours at 40 ° C. After cooling to room temperature, the solution was slowly dripped into 200 ml isopropyl ether, and the white precipitates were collected by centrifugation. The precipitate was dissolved in acetonitrile and then carried on the precipitation centrifugation process for another two times. For ATRP, 0.8g QDMAEMA and 200 μL PMDETA were added into a 10 ml mixture of deionized water and methanol (volume ratio=1:1) in a 50 ml flask. Under the protection of nitrogen, 20 mg CuBr₂ and 0.2 g UiO-66-BiBB were added to the mixture. After nitrogen bubbling for 20 minutes, 64.8 mg CuBr was added into the flask, which was then tightly sealed. After stirring for 36 hours at 30 ° C., the PQDMAEMA-modified UiO-66-BIBB was prepared (denoted as UiO-PQDMAEMA). The samples were separated by centrifugation and washed by deionized water and methanol for 3 times. Finally, the obtained particles were naturally dried in the air.

### Fabrication of Face Mask Filter

The face mask filter was fabricated via the facile electrospinning method, where the electric force is generated by a high voltage to draw threads of polymer solutions to fibers with diameters in the order of hundred nanometers.[46] Four different DMF (N, N-dimethylformamide) solutions of PAN (6 wt % PAN loading), UiO-66-NH_{2@}PAN (60 wt % MOF loading), UiO-PQDMAEMA@PAN (60 wt % UiO-PQDMAEMA loading), and Cu@PAN (60 wt % Cu(NO)₃·3H₂O loading) were used as the precursors for the nanofibers. The electrospinning process was operated at a precursor flow rate of 0.5 ml/hour. A high voltage of 17 kV was applied and the distance between the collector and spinneret was set at 17 cm. The obtained fibers were collected on the substrate of stainless-steel mesh (from McMaster-Carr). The temperature and relative humidity (RH) were kept at 50° C. and 10%, respectively.

### Materials Characterization

The surface functional groups of the samples were analyzed by a Fourier transform infrared (FT-IR) spectrometer (Nicolet iS50). X-ray diffraction (XRD) patterns were collected by the PANalytical X′Pert Pro MPD. Morphologies of the samples were observed by SEM (scanning electron microscopy, Su-70, Hitachi) and TEM (transmission electron microscopy, JEOL JEM-F200). Thermogravimetric analysis (TGA) was conducted with a TA Q500 under nitrogen gas flow with a heating rate of 10° C./min. The gas adsorption experiments were carried out using Autosorb iQ (Quantachrome Instrument). The fluorescence images were obtained by the Zeiss Axiovert 200M fluorescence microscope. The surface compositions were determined by the X-ray photoelectron spectrometer (XPS, Thermo Scientific ESCALAB 250).

### Particulate Filtration Tests

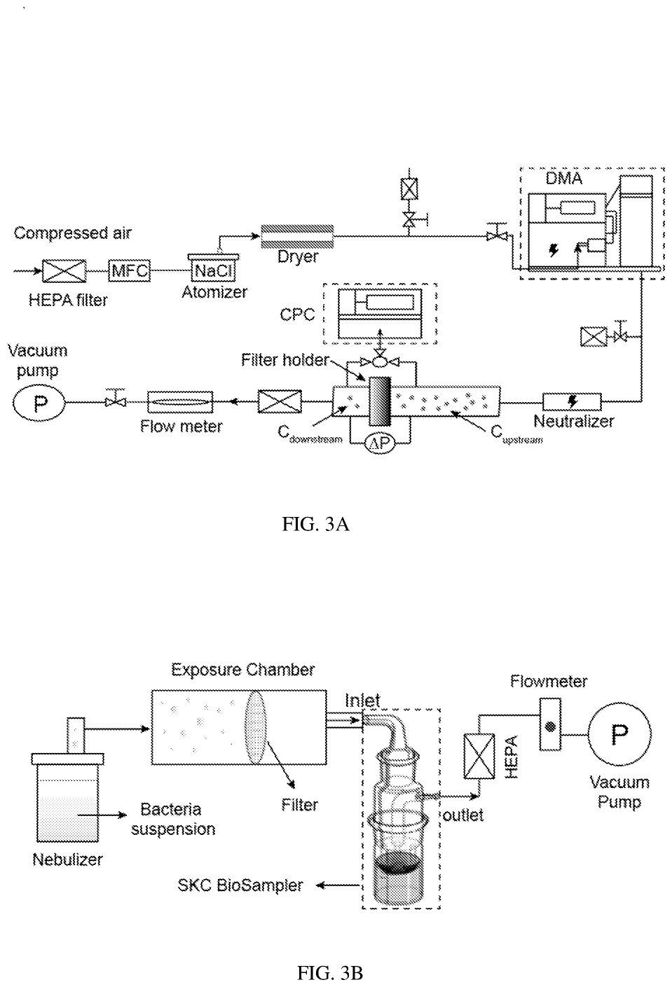

The particle filtration tests were conducted based on the ISO standard (ISO 21083-1:2018) for the flat sheet media and the experimental system is shown in FIG. 3a.[47] The particle filtration efficiency of as-synthesized filters was tested under 9.3 cm/s face velocity which is within the media face velocity ranges in the N95 test (˜5-10 cm/s).[48, 49] In brief, monodisperse sodium chloride (NaCl) particles were generated by an atomizer (TSI model 9302, TSI Inc.) and classified by a differential mobility analyzer (DMA, Model 3082, TSI Inc.) with sizes of 20, 30, 50, 80, 100, 150, 200, 300, 400, and 500 nm. Before challenging the filter media, the classified monodisperse particles were neutralized by a Po 21° neutralizer to minimize the particle charge for mimicking the charging condition of ambient particles, which are normally in Boltzmann equilibrium.[44] An ultrafine condensation particle counter (UCPC, Model 3776, TSI Inc.) operated at 1.5 L/min and a three-way valve were used to measure the upstream and downstream particle number concentrations of the filter media. For comparison, the filtration performance of a commercial N95 respirator from VWR (Makrite) was also tested, in which a relatively flat portion of the respirator was cut out to form a flat sheet and the aforementioned same filtration procedure was applied.

The size-fractionated penetration, P (dₓ), representing the fraction of particles with diameter dₓ can go through the filter medium, is defined as:

$$P ( {d}_{x} ) = \frac{{C ( {d}_{x} )}_{downstream}}{{C ( {d}_{x} )}_{upstream}} \qquad ( 1 )$$

where C(dₓ)_{downstream} and C(dₓ)ᵤₚₛₜᵣₑₐₘ are the downstream and upstream number concentrations of dₓ particles, respectively. The size-fractionated filtration efficiency, PFE(dₓ), of the filter is thus calculated as:

PFE(dₓ)=1−P(dₓ) (2)

To correct the size-fractionated particle filtration efficiency (PFE (d r)) due to the particle diffusion loss, the correlation ratio test was performed. The same particle generator as used for generating challenge aerosols for the test was turned on, but without a test filter medium in the holder. The upstream and downstream samples were measured for the same sampling time internals as used in the tests. The general formula for the correlation ratio, R(dₓ), can be calculated as:

$$R ( {d}_{x} ) = \frac{{C ( {d}_{x} )}_{downstream , 0}}{{C ( {d}_{x} )}_{upstream , 0}} \qquad ( S1 )$$

where C(dₓ)_{downstream,0} is the particle concentration with particle size dₓ measured at the downstream sampling location without a filter medium; C(dₓ)_{upstream,0} is the particle concentration with the particle size dₓ measured at the upstream sampling location without a filter medium. The finally corrected PFE′(dₓ) takes the following form:

$${PFE}^{′} ( {d}_{x} ) = 1 - \frac{P ( {d}_{x} )}{R ( {d}_{x} )} \qquad ( S2 )$$

The upstream and downstream particle concentrations were measured for at least three times to obtain the representative filtration results. The standard deviation (σ(dₓ)) was calculated using the following equation:

$$σ ( {d}_{x} ) = \frac{{C ( {d}_{x} )}_{downstream}}{{C ( {d}_{x} )}_{upstream}} \sqrt{( {( \frac{{σ}_{downstream}}{{C ( {d}_{x} )}_{downstream}} )}^{2} + {( \frac{{σ}_{upstream}}{{C ( {d}_{x} )}_{upstream}} )}^{2} )} \qquad ( 3 )$$

where σ_{downstream} and σ_{downstream} are the standard deviations at the downstream and upstream of the filter holder, respectively. [50]

### Bacteria Filtration Tests

A system for bacteria filtration tests was also developed in this study (FIG. 3b). Specifically, two representative bacteria S. epidermidis (Gram-positive) and E. coli (Gram-negative) suspensions with a density at 10⁷ CFU/mL in phosphate-buffered saline (PBS) solution were used as precursors. Then, the suspensions were atomized by an ultrasonic nebulizer operated at 2.4 MHz to generate bioaerosols to challenge the filters at a flow rate of 12.5 L/min for 1 minute. A BioSampler (SKC Inc.) containing 20 ml sterile PBS solution was used to collect the escaped bioaerosol. After collection, the escaped bacteria concentrations were determined by the standard plate counting method. The plates were incubated at 37° C. for 20 hours, and the number of colonies was enumerated through visual inspection. The bacterial filtration efficiency (BFE) of the filter is defined as follows:

$$BFE = 1 - \frac{{C}_{f}}{{C}_{total}} \qquad ( 4 )$$

where C_{f} (CFU/ml) is the bacteria concentration in the Biosampler with a face mask filter operation; Cₜₒₜₐₗ (CFU/ml) is the bacteria concentration in the Biosampler without a mask filter operation.

### Bacteria Inactivation Assessments

After being challenged by the bioaerosol for 1 minute, the filter was sealed in a petri dish and placed in the dark for 2 hours to allow the interaction between the filter surface and captured bacteria. Subsequently, the filter was vortexed at 5000 rpm for 5 minutes to resuspend the captured bacteria in the 20 ml PBS solution. Then, the suspension was diluted with PBS, and 3 μL of each decimal dilution was dropped in the sterile nutrient agar culture plates. The agar plates with the bacteria suspensions were incubated at 37° C. for 20 hours to give the visible colonies, which were enumerated to calculate the number of living bacteria.

The bacteria inactivation efficiency (BIE) was calculated by the following equation:

$$BIE = 1 - \frac{{C}_{live}}{{C}_{total}} \qquad ( 5 )$$

where C it y, is the concentration of live bacteria remaining on the filter. Additionally, after being placed in the dark for 2 hours, the filter was cultured in the nutrient agar at 37° C. for 20 hours for residual analysis of remained viable cells.

Fluorescence microscopy is a useful technique to examine the viability of bacterial cells before and after contacting the filter. To perform this analysis, 1 ml bacteria cell suspension was centrifuged and resuspended in 10 μL of PBS solution, which was subsequently stained by a live/dead staining kit (Molecular Probes, Invitrogen) in the dark for 1 hour. Bacterial cells with intact cell membranes (live) were stained by SYTO 9 and fluorescent green, whereas propidium iodide (PI) penetrates only damaged membranes and stains the dead bacteria, which presented red fluorescence.

### Results and Discussion

### Characterization of UiO-66-NH₂, UiO-BIBB, and UiO-PQDMAEMA

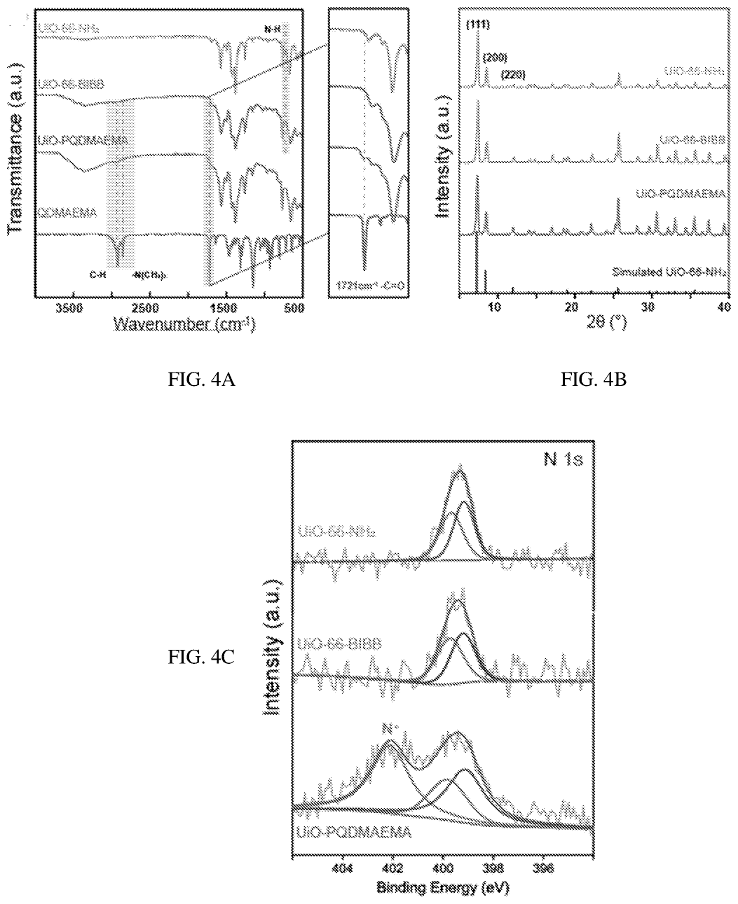

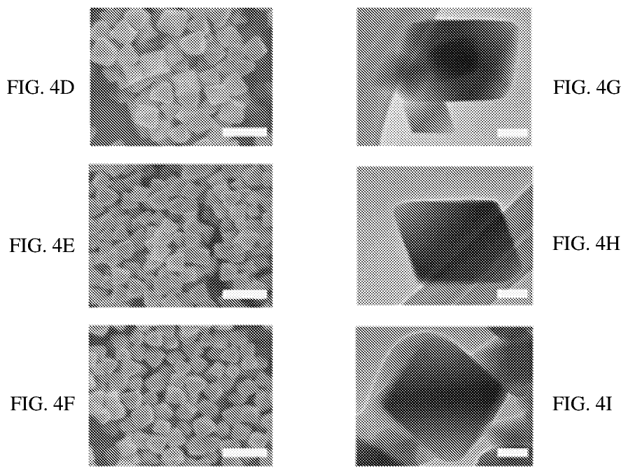

The surface chemistry of UiO-66-NH₂, UiO-66-BIBB, UiO-PQDMAEMA, and monomer QDMAEMA were analyzed by FT-IR as shown in FIG. 4a. It is found that the peak at 768 cm⁻¹ in the raw UiO-66-NH_{2,} attributed to the N-H wagging vibrations, [51] disappears in UiO-66-BIBB after modifications. This indicates that the initiator BIBB is successfully anchored on the —NH₂ group of UiO-66-NH₂ via covalent bonding. After ATRP reaction, an emerging peak at 1721 cm -1 is found in UiO-PQDMAEMA, which originates from the C═O stretching vibration of ester groups from QDMAEMA[52]; Besides, two additional peaks at 2822 cm⁻¹ and 2770 cm⁻¹ are also observed in UiO-PQDMAEMA, which are assigned to the —N(CH₃)₂ symmetric and asymmetric vibrations from QDMAEMA, respectively.[53] Therefore, it can be concluded that PQDMAEMA is successfully grafted onto UiO-66-NH₂ via ATRP.

In addition to the surface chemistry, the crystalline structures of UiO-66-NH₂, UiO-66-BIBB, and UiO-PQDMAEMA were examined by XRD. As shown in FIG. 4b, the XRD pattern of the as-synthesized UiO-66-NH₂ is well consistent with the simulated one, where the characteristic peaks at 7.4° and 8.8° are attributed to the (111) and (200) crystal planes, respectively.[54] It is noted both UiO-66-BIBB and UiO-PQDMAEMA share almost the same XRD patterns as UiO-66-NH₂, indicating that the crystalline structure of UiO-66-NH₂ is maintained after BIBB treatment and polymerization. The unchanged crystalline structure of UiO-66-NH₂ throughout the entire synthesis procedures also implies that the UiO-66 modified materials are very stable, which is favorable for the post-processing and applications.

To further elucidate the evolution of nitrogen from the —NH₂ group in UiO-66-NH₂, the near-surface elemental information was determined by the XPS measurements. FIG. 4c shows the deconvoluted N is core-level peaks of UiO-66-NH₂, UiO-66-BIBB, and UiO-PQDMAEMA. The XPS spectra of UiO-66-NH₂ and UiO-66-BIBB exhibit two nitrogen peaks at 398.9 eV and 399.8 eV, which are assigned to N—H and C—N, respectively.[55] A new peak at 402.0 eV is found in UiO-PQDMAEMA, which is attributed to the C—N⁺ component from the monomer QDMAEMA, confirming that an outer quaternized surface layer is formed.[35] Based on the XPS spectra in FIG. 4c, the quaternization degree (QD) of UiO-PQDMAEMA was estimated to be 48%.[56]

The morphologies of UiO-66-NH₂, UiO-66-BIBB, and UiO-PQDMAEMA were also observed by SEM. As shown in FIGS. 4(d, e, g, h), UiO-66-BIBB has similar crystal shapes to that of UiO-66-NH₂ with an average particle size of ˜265 nm. After the ATRP reaction, the surface of UiO-PQMAEMA becomes smooth (FIG. 4f), and an obvious polymer shell can be observed in its TEM image (FIG. 4i). Understandably, the core contour and size are similar to those of unmodified UiO-66-NH₂, which is well consistent with the XRD results in FIG. 4b. According to the TGA results, the percentage of polymer in UiO-PQDMAEMA was estimated at 9.93%. All the above results once again confirm the successful grafting of PQDMAEMA onto UiO-66-NH₂.

### Fabrication of UiO-PQDMAEMA@ PAN Filter Via Electrospinning

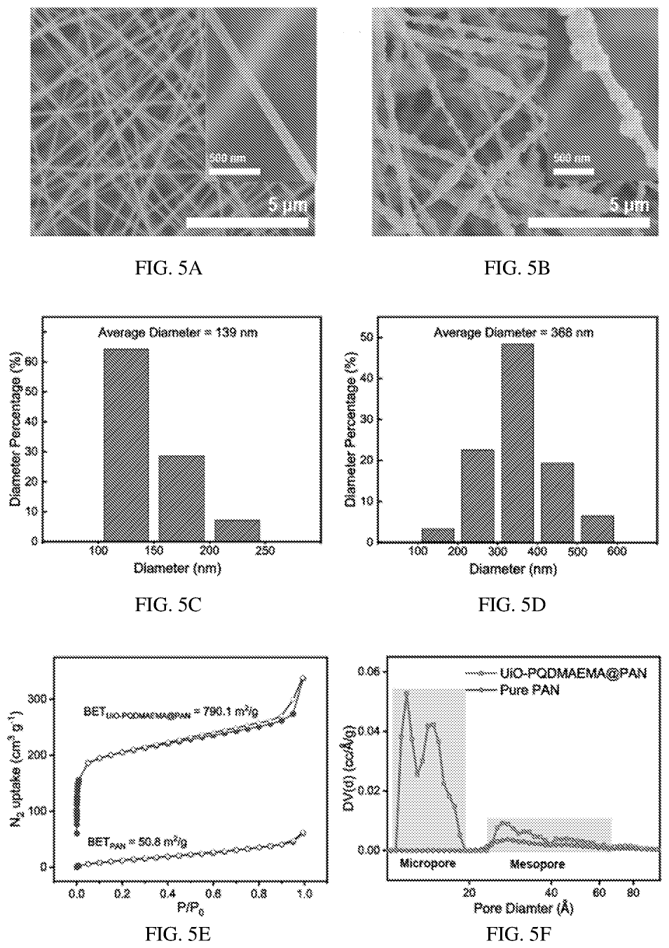

To fabricate composite nanofibers by using the electrospinning approach, a precursor solution of polymer and filler particles is generally used, resulting in the production of composite nanofibers where the filler particles are uniformly distributed inside the polymer backbone.[19] This homogeneous structures are often undesirable as the functionality of the embedded fillers cannot be fully exploited. This is especially true in this work. To take full advantages of the surface properties of UiO-PQDMAEMA for efficient contact-killing bactericidal assays, the UiO-PQDMAEMA particles should be exposed on the surface of the polymer fibers. However, selective coating of the UiO-PQDMAEMA particles on the PAN fiber surface by using a single-step electrospinning method is challenging. In this work, we developed an engineering approach to rationally tune the diameter of the backbone support PAN fibers smaller than that of the filler UiO-PQDMAEMA particles (d≅213 nm, FIG. 4f) to expose them on the surface of the PAN fiber. Because the terminal fiber diameter (d_{f}) in electrospinning is determined by an equilibrium between the repulsive electrostatic force and liquid's surface tension, it can be predicted by the following equation: [57]

$${d}_{f} ∼ {( γ \frac{{Q}^{2}}{{I}^{2}} )}^{\frac{1}{3}} {w}_{p}^{\frac{1}{2}} \qquad ( 6 )$$

where γ is the surface tension of the polymer solution, Q is the feeding flowrate, I is the electric current in the system, and wₚ is the polymer volume fraction. Besides, the surface tension is also a function of temperature, which can be expressed as:

$$γ = {{γ}^{0} ( 1 - \frac{T}{{T}_{c}} )}^{n} \qquad ( 7 )$$

where γ⁰ is the constant for each liquid, n is a positive empirical factor, T_{c} is the critical temperature and T is the actual temperature. To obtain thinner fibers, we rationally decrease the γ of PAN/DMF solution by increasing the working temperature to 50° C., given that Q, I, and wₚ are all fixed in our system. Furthermore, the working RH was kept at a low level of 10% to generate the thinner nanofibers because a lower RH would favor the solvent evaporation and thus the solidification rate of the jet.[59] Not surprisingly, the defect-free and uniform nanofibers are observed in the pure PAN filter (FIG. 5a). The average diameter of pure PAN fibers is measured to be ˜139 nm (FIG. 5c), which is thinner than those fabricated at room temperature (25° C.) and higher RH of 35% with an average diameter size of 242 nm. FIG. 5b shows the morphology of the UiO-PQDMAEMA@PAN filter, where the UiO-PQDAMEMA particles are well decorated on the PAN fiber surface with an overall average diameter of 368 nm (FIG. 5d). The exposure of the UiO-PQDMAEMA particles to the environment (FIG. 5b) gives them more contacting opportunities with captured bacteria. The nitrogen sorption isotherms of the pure PAN and UiO-PQDMAEMA@PAN filters are shown in FIG. 5e. With the successful integration of porous UiO-PQDMAEMA into the PAN fibers, the BET surface area is increased to 790.1 m² g⁻¹, which is much higher than the pure PAN filter of 50.8 m² g¹. For UiO-PQDMAEMA@PAN, the rapid increase in N₂ uptake at a low relative pressure (P/P₀<0.01) indicates the abundance of micropores (pore size<20 Å), which is due to the existence of UiO-PQDMAEMA, while the slight increase at high relative pressure and the existence of hysteresis suggest the presence of mesopores (200 Å>pore size>20 Å).[60] Compared to the pure PAN with only mesopores, the UiO-PQDMAEMA@PAN filter

exhibits a hierarchical structure containing the characteristics of both micropores and mesopores (FIG. 5f). Moreover, XRD and FT-IR analyses indicate that the crystalline structure and surface chemistry of the UiO-PQDMAEMA are retained after the electrospinning process.

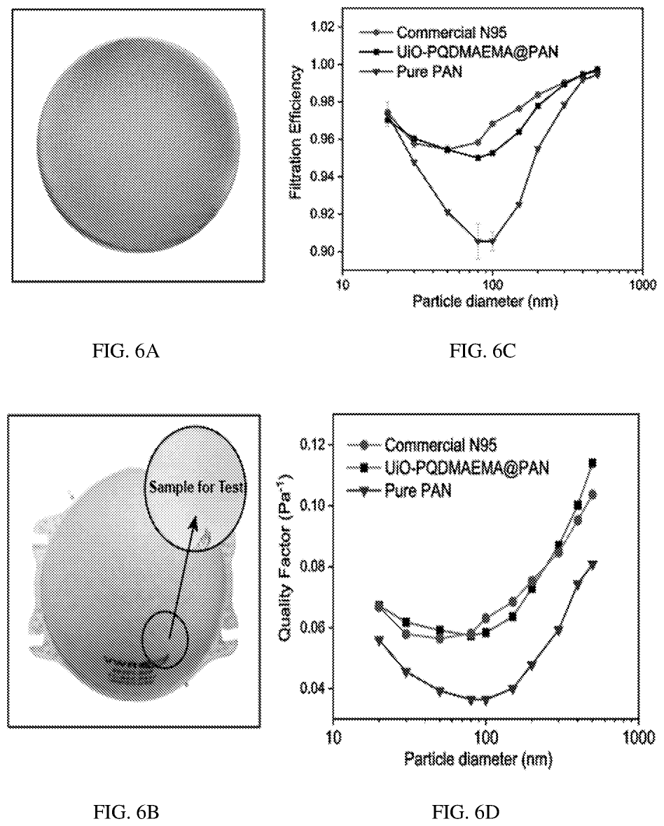

The particle filtration performances of the UiO-PQDMAEMA@PAN filter (shown in FIG. 6a) and the N95 (shown in FIG. 6b) were tested by the experimental setup shown in FIG. 3a. It should be noted that the particle filtration efficiency measured throughout the study is the initial particle filtration efficiency as the challenging particles were low concentration monodisperse particles due to the classification of DMA. Thus, the loading effects can be

neglected.[61, 62] According to the classic filtration theory,[63] when the particles pass through the fibrous filter, they are captured by the fiber through a combination of mechanisms including direct interception, inertial impaction, Brownian diffusion, gravitational settling, and electrostatic attraction. For the particles captured at a specific size, the predominant mechanisms vary based on the properties of the tested filters.[64] Therefore, each filter often has a specific size-fractionated efficiency curve. FIG. 6c compares the efficiency curves amongst the pure PAN, UiO-PQDMAEMA @PAN, and N95 filters. It is seen that the particle filtration efficiency decreases with particle size until it reaches the most penetrating particle size (MPPS) at around 80 nm, and subsequently increases for particles greater than 80 nm. By controlling the volume of the precursors, the thickness of the UiO-PQDMAEMA @PAN filter is adjusted to 16 μm, and the minimum filtration efficiency of as-synthesized UiO-PQDMAEMA@PAN filter at 80 nm is measured to be ˜95.1%. The filtration performance is comparable to that of a commercial N95 respirator, which makes the UiO-PQDMAEMA@PAN a candidate for an N95 respirator filter medium. It is noted that as compared to the pure PAN filter tested under the same pressure drop (52.3 Pa), a higher filtration efficiency is obtained for the UiO-PQDMAEMA@PAN filter. This is probably due to the higher fiber charge, chaotic airflow and larger local fiber diameter favorable for interception and diffusion depositions by the hierarchical MOF particles within the electrospun fibers.[65-67] As shown in FIG. 5f, the UiO-PQDMAEMA@PAN filter is endowed with hierarchical structures, which contain both micropores and mesopores by embedding the porous UiO-PQDMAEMA particles in the electrospun fibers. The pressure drop is another very important parameter, as breathing air behind the face mask requires significant pressure or energy provided by the users, which is highly related to wearer's comfort and health during breath. Therefore, a low-pressure drop is always a desirable filter property. The quality factor (QF), a comprehensive parameter, is used to evaluate the filtration performance of the filter media, which takes both efficiency and pressure into account. The QF is defined as:

$$QF = - \frac{ln ( 1 - PFE )}{Δ P} \qquad ( 8 )$$

where PFE and ΔP are the particle filtration efficiency and pressure drop across the filter, respectively. The higher the QF, the better the filter is. Given that the higher QF values are obtained as compared to the pure PAN, the UiO-PQDMAEMA@PAN filter has a much better filtration performance because of the incorporation of UiO-PQDMAEMA in the electrospun nanofibers. Additionally, the minimum QF value of the UiO-PQDMAEMA@PAN filter is calculated to be 0.058 at MPPS of 80 nm, which is comparable to that of 0.056 for the commercial N95 respirator at 50 nm, indicating that the UiO-PQDMAEMA@PAN filter demonstrates a satisfactory filtration performance.

### Evaluation of Bacteria Filtration Performance

The bacteria filtration performance of the UiO-PQDMAEMA@PAN filter is evaluated by challenging with the bioaerosols containing S. epidermidis (Gram-positive bacteria) and E. coli (Gram-negative bacteria). The schematic diagram of the experimental setup for the bioaerosol filtration is shown in FIG. 3b. The BioSampler (SKC Inc) which combines impingement with centrifugal motion is used for the escaped bacteria collection.

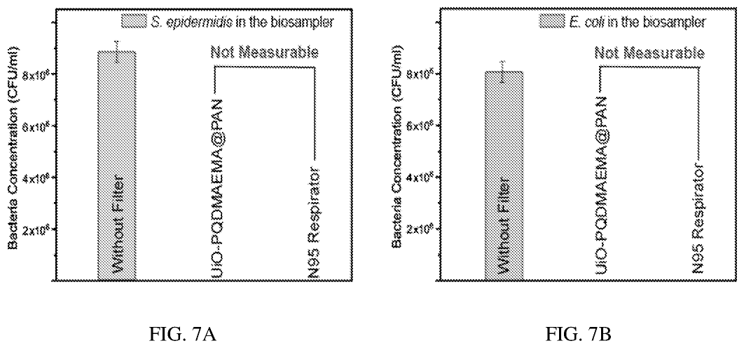

Specifically, there are three collection nozzles positioned at a specific angle above the collection sterile PBS solution during the sampling, and the air stream with bacteria is directed to the wall of the sampling where a liquid film is formed due to the centrifugal motion of the liquid.[69] This design lowers the microorganism stress as compared to the conventional impinger and ensures the viability of the collected bacteria, which makes SKC BioSampler a reliable and de facto reference sampler in bioaerosol studies.[70] The recommended air flowrate for the N95 respirator test is 28.3 L/min by the U.S. Food and Drug Administration (FDA),[71] where the face velocity is calculated to be 3.1 cm/s.[71] In our system, the face velocity of the tested filter is calculated to be 10.5 cm/s, given that the working flowrate of the BioSampler should be fixed at 12.5 L/min to ensure the accuracy of the bacteria collection.[72] As shown in FIG. 7(a, b), no bacteria of S. epidermidis and E. coli are found after passing through the UiO-PQDMAEMA@PAN filter as well as the commercial N95 respirator, which indicates that all the airborne bacteria are completely captured by the filter even at a high face velocity of 10.5 cm/s. The reason for the airborne bacteria that cannot pass through the UiO-PQDMAEMA@PAN filter is mainly due to their sizes. Both S. epidermidis and E. coli have sizes in the range from 0.5 to 2 μm, which is much larger than the MPPS (<100 nm) as discussed above. Therefore, the bacteria filtration of these filters is much more efficient. In summary, the as-synthesized UiO-PQDMAEMA@PAN filter demonstrates an excellent performance towards bacteria capture, which could be used to protect user's safety by blocking out the routes of airborne bacteria transmission.

### Bactericidal Evaluation of UiO-PQDMAEMA@PAN Filter

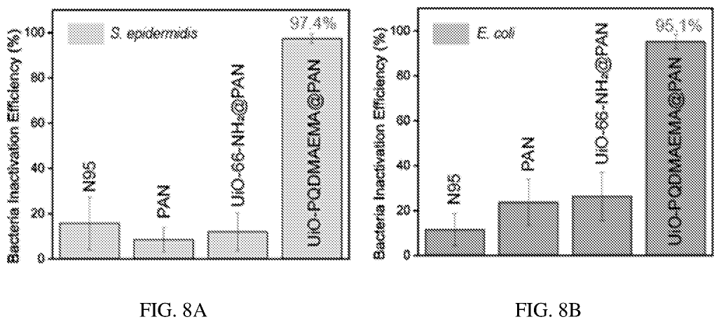

The bacteria inactivation performance of the UiO-PQDAMEMA@PAN filter was also evaluated towards both S. epidermidis and E. coli. Control experiments of pure PAN filter and UiO-66-NH₂@PAN filter were also conducted for comparison. As shown in FIG. 8(a, b), both pure PAN and UiO-66-NH₂@PAN filters show limited capabilities of killing bacteria while the UiO-PQDMAEMA@PAN filter has a significant inactivation efficiency of ˜97.4% of S. epidermidis and ˜95.1% of E. coli, indicating that the grafted UiO-PQDMAEMA on the surface of PAN fibers enables the filter to have efficient bactericidal behaviors. Further live/dead bacteria fluorescence assays using LIVE/DEAD kit were also conducted to investigate the bactericidal effects of the UiO-PQDMAEMA@PAN filter. Before conducting the experiments, most bacteria were alive and stained by SYTO 9, therefore, numerous green dots are observed. However, the number of dead bacteria, which emit the red fluorescence was increased significantly after contacting the surface of the UiO-PQDMAEMA@PAN filter, implying that the membrane integrity of bacterial cells is disrupted. Meanwhile, the ratio of live and dead bacteria in fluorescence images shows almost no change in the control group of pure PAN and UiO-66-NH₂@PAN filters once again confirming the bactericidal behaviors of the UiO-PQDMAEMAM@PAN filter. The commercial N95 respirator was also tested towards bactericidal performance. As shown in FIG. 8(a, b), negligible bacterial inactivation efficiencies can be obtained for S. epidermidis and E. coli, indicating that most of the adhered bacteria are still alive, which is the main reason that the contaminated respirator could be the source of HAIs transmission. As compared to the commercial N95 respirator, the as-synthesized UiO-PQDMAEMA@PAN filter demonstrates an efficient and rapid bacteria inactivation performance, which makes it useful for the antibacterial filter in the N95 level respirator.

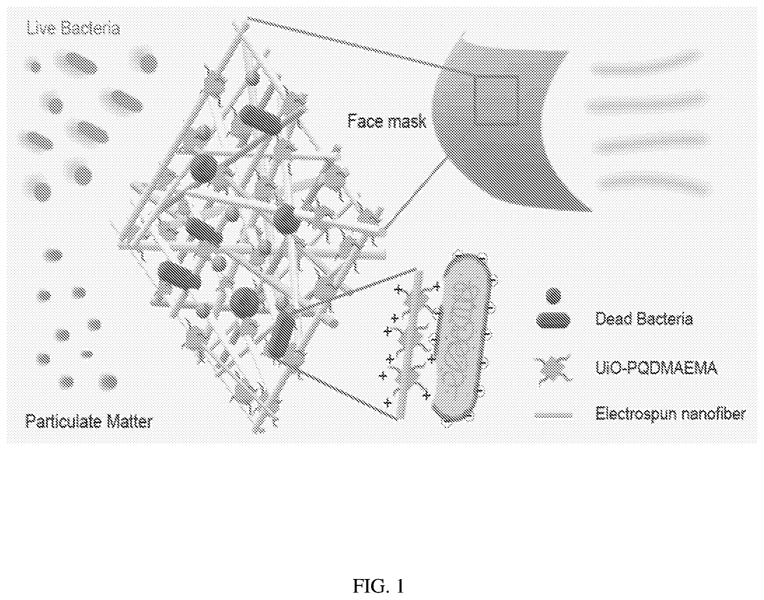

Since typical bactericidal activities of QAC-based polymers are based on the contact killing mechanism, where the electrostatic interactions between negatively charged bacteria cell wall and positively charged QAC-based molecules are mainly responsible for the disruption of bacteria membrane, two prerequisites should be satisfied to endow the materials to have efficient antibacterial performance. [42, 73] One is the enough contacting time between bacteria and QAC-modified surfaces, and the other is that a threshold of charge density should be reached. In this study, when the airborne bacteria are captured by the filter, they are trapped by multiple nanofibers containing numerous contacting sites of positively charged UiO-PQDMAEMA (N±). (FIG. 1, FIG. 4c) From the time course of bacteria inactivation, the UiO-PQDMAEMA@PAN filters exhibit limited bactericidal performance within the first 30 minutes, which is probably due to the insufficient interactions between bacterial cell wall and UiO-PQDMAEMA particles. When the contacting time extended to 2 hours, 97.4% of S. epidermidis and 95.1% E. coli were finally killed. Compared to the Gram-positive bacteria S. epidermidis, the Gram-negative bacteria E. coli exhibited a relatively greater resistance to contact disinfection, as shown in FIG. 8, indicating a difference in physicochemical interaction with the UiO-PQDMAEMA@PAN. The discrepancy in the antibacterial efficiency could be caused by various cell structures between the Gram-positive bacteria and the Gram-negative bacteria. The Gram-positive bacterial cell wall is composed of a simple layer of peptidoglycan. This layer has numerous pores, which allow the QAC molecules to readily penetrate the thick cell wall and reach the cytoplasmatic membrane.[75] However, the cell wall of the Gram-negative bacteria E. coli is comprised of two membranes reinforced by the expression of lipopolysaccharide on the cellular surface, which provides an additional protective property.[76] Therefore, a more efficient antibacterial performance was obtained towards S. epidermidis than E. coli.

The positive charge density of outer layer is another key parameter to define antibacterial efficacy.[74] For S. epidermidis and E. coli inactivation, the prerequisite charge density should be above the critical threshold of 1×10¹²-10¹⁴ N⁺/cm².[77, 78] To calculate the charge density of UiO-PQDMAEMA, we used the crystal in FIG. 4i for further estimation. The crystal in red contour is the initial UiO-66-NH₂, which is decorated by a layer of QAC polymer. Assuming that charges were uniformly distributed within the polymer layer, the charge density (CD) can be determined by the following equation:

$$CD = \frac{Q}{A} \qquad ( 9 )$$

where Q is the surface charge and A is the surface area. The CD of UiO-PQDMAEMA was calculated to be 3×10¹⁴ N⁺/cm². Therefore, UiO-PQDMAEMA in this work is expected to exhibit effective antibacterial actions. Besides, the monomer DMAEMA is quaternized by 1-bromodecane to impart the QDMAEMA with 10 carbon atoms in the alkyl chains (FIG. 2). The relatively long alkyl chains in UiO-PQDMAEMA could interact strongly with the peptidoglycan cell wall and, finally, bacteria are killed by the lysis of their cytoplasm.[41]

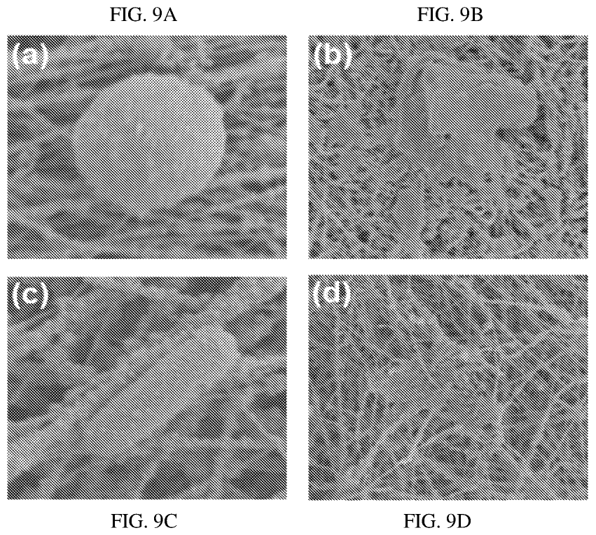

To further unravel the interactions between UiO-PQDMAEMA@PAN filter and bacteria, the morphologies of S. epidermidis and E. coli were observed by SEM. As shown in FIG. 9(a, c), the cells of S. epidermidis and E. coli maintained intact upon initial contact with the UiO-PQDMAEMA filter. After contacting treatment for 2 hours, the shapes of both S. epidermidis and E. coli are deformed, and the cell membranes are severely damaged (FIG. 9 (b, d)), which indicates that the QAC modified MOF enables the electrospun filter with efficient antibacterial capability against both Gram-negative and Gram-positive bacteria.

### Leakage Evaluation

The leakage of the antibacterial agent during the filtration and antimicrobial activity is a serious issue because improper intake of these chemicals would result in severe health issues.[79] Among the commercial antimicrobial face masks and respirators, Ag⁺ and Cu²⁺ are the two most frequently used metal ions in the filter media to inactivate microorganisms.[80] Herein, we fabricated a Cu²⁺-loaded PAN filter (Cu@PAN) for comparison. To examine the leakage behaviors, both UiO-PQDMAEMA@PAN and Cu@PAN filters were immersed in 100 ml DI water for 2 hours. Then, 1 ml AgNO₃ (1 mM) and Na₂S (1 mM) were added into UiO-PQDMAEMA@PAN and Cu@PAN solutions, respectively. The rationale for designing the leakage test is as follows. For the UiO-PQDMAEMA@PAN filter, there might be some Br⁻ released from the 1-bromodecane (C₁₀H₂₁Br) in the UiO-PQDMAEMA particles (see FIG. 2 for details). If Br is leaked from the filter, it would react quickly with Ag⁺ to form a yellow precipitate, AgBr. Similarly, the Cu²⁺ released from Cu@PAN filter would combine with S²⁻ in the Na₂S solution to produce CuS precipitates. No color change is observed in the UiO-PQDMAEMA@PAN beaker after AgNO₃ titration, indicating there is negligible Br leakage. While the solution turned brown in the Cu@PAN beaker, which is caused by the formation of a low concentration of CuS precipitates. As compared to the Cu@PAN filter, negligible leakage was found in the UiO-PQDMAEMA@PAN immersed in the water, indicating that the UiO-PQDMAEMA@PAN filter is safe for humans and environmentally friendly.

### Conclusion

In summary, we designed an antibacterial filter where the QAC modified MOF (UiO-PQDMAEMA) was incorporated into the electrospun PAN fibers. The antibacterial agent polymeric QACs (PQDMAEMA) was grafted onto the surface of UiO-66-NH₂ via ATRP. To partially expose the surface of the UiO-PQDMAEMA particles, the backbone electrospun PAN nanofibers were produced at an enhanced working temperature of 50° C. and low RH of 10%. The as-synthesized UiO-PQDMAEMA@PAN filter exhibited a satisfactory performance towards PM filtration and bacterial blockage, which is comparable to those of the commercial N95 respirator. In particular, the UiO-PQDMAEMA@PAN filter demonstrated excellent bactericidal activities towards both Gram-positive S. epidermidis and Gram-negative E. coli via a contact-killing mechanism. The incorporated UiO-PQDMAEMA particles with positively charged nitrogen (N⁺) in the long alky chain resulted in the deformation and damage of cells after electrostatic interactions between UiO-PQDMAEMA and bacteria. The current work indicates that the UiO-PQDMAEMA@PAN is a comprehensive protection core filter for the N95 respirator or other face masks against PM and airborne bacteria. This study also sheds light on the design of QAC modified antibacterial materials and paves a way for the application of these materials in air cleaning.

### EXAMPLE 2

### Summary

The same design strategy as described in Example 1, i.e., using positively charged QDMAEMA, can be applied to additional variations of filter media, such as g-C₃N₄@MIL-125-NH₂@QDMAEMA (C-M-Q). Graphitic carbon nitride (g-C₃N₄) is a family of carbon nitride compounds with a general formula near to C₃N₄ (albeit typically with non-zero amounts of hydrogen) and two major substructures based on heptazine and poly(triazine imide) units. Graphitic carbon nitride can be made by polymerization of cyanamide, dicyandiamide or melamine. In addition to the antimicrobial capability, this composite (C-M-Q) is also able to adsorb toxic air contaminants, such as toluene. C-M is an abbreviation for g-C₃N₄@MIL-125-NH₂, which is the foundation for the improved antibacterial performance and toxic gas adsorption. The as-synthesized C-M is an efficient photocatalyst, which can disinfect pathogens by radical oxygen species (ROS) generated under the light irradiation. The ROS can kill pathogens efficiently by causing oxidative damage to all kinds of cell components, including nucleic acids, lipids, and proteins.

### Experimental Details and Results

Graphitic carbon nitride (g-C₃N₄) was prepared as follows: 10 g urea (Sigma Aldrich, 99.0-100.5%) was put in an alumina crucible with a cover. Then, the crucible was heated to 550° C. at a rate of 0.5° C./min in a muffle furnace and maintained at this temperature for 3 hours. The yellow g-C3N4 was obtained after cooling down to the room temperature.

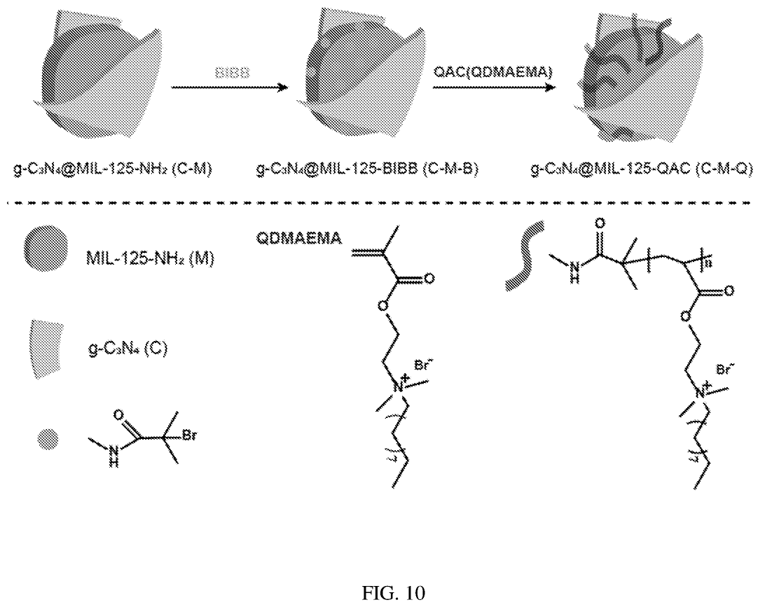

In g-C₃N₄@MIL-125-NH₂ (C-M), g-C₃N₄ (C) is a very efficient visible-light-responsive photocatalyst due to its suitable electronic band structures. MIL-125-NH₂ (M) is a characteristic Ti-based metal-organic framework (MOF), which is water-resistant and has a superior surface area. With reference to FIG. 10, to synthesize the composite, we first placed the previously prepared g-C₃N₄ in the precursor of MIL-125-NH₂, which was then solvothermally treated in a Teflon-lined autoclave. After being heated for 16 hours, C-M was obtained with a heterojunction formed inside the material structure. The promoted charge transfer caused by the heterojunction in C-M can boost the generation of (ROS) under visible light irradiation in water.

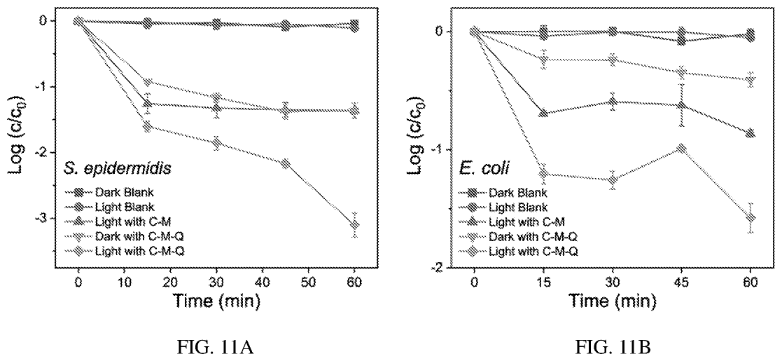

To further enhance the antibacterial performance, we modified the C-M with QDMAEMA (Q) via atomic transfer radical polymerization (ATRP) approach to form the composite C-M-Q. Even though the QDMAEMA (Q) itself can kill bacteria, the process takes much longer as the electrostatic interaction should be strong and long enough to destroy the bacteria membrane. In C-M-Q, a cooperative strategy was used to significantly improve the antibacterial performance Specially, the antibacterial agent QDMAEMA (Q) is positively charged, which can also help C-M-Q adhere the negatively charged bacteria moving towards the material's surface. In this way, the diffusion distance of ROS in the water is also shortened. Therefore, a much more significant antibacterial performance was observed in the CFU results (FIG. 11A-B).

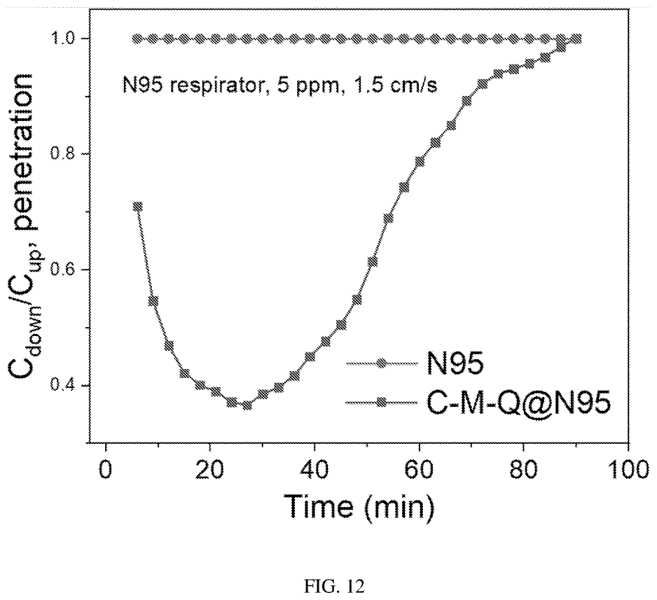

In addition to the antibacterial performance, C-M-Q can also adsorb toxic gas molecules (e.g., toluene) because of the high porosity and surface area of MIL-125-NH₂. We coated 20 mg C-M-Q on a 1-inch filter cut from N95 respirator and challenged by 5 ppm toluene gas at face velocity of 5 cm/s. The concentration of toluene at upstream and downstream was determined by gas chromatography (GC). The results showed that the C-M-Q coated filter can provide 58% protection against toluene gas (FIG. 12).

### References

1. A. Y. Peleg and D. C. Hooper, Hospital-Acquired Infections Due to Gram-Negative Bacteria, N. Engl. J. Med., 2010, 362, 1804-1813.
2. S. S. Magill, E. O'Leary, S. J. Janette, D. L. Thompson, G. Dumyati, J. Nadle, L. E. Wilson, M. A. Kainer, R. Lynfield, S. Greissman, S. M. Ray, Z. Beldays, C. Gross, W. Bamberg, M. Sievers, C. Concannon, N. Buhr, L. Warnke, M. Maloney, V. Ocampo, J. Brooks, T. Oyewumi, S. Sharmin, K. Richards, J. Rainbow, M. Samper, E. B. Hancock, D. Leaptrot, E. Scalise, F. Badrun, R. Phelps and J. R. Edwards, Changes in Prevalence of Health Care-Associated Infections in U.S. Hospitals, N. Engl. J. Med., 2018, 379, 1732-1744.
3. S. S. Magill, J. R. Edwards, W. Bamberg, Z. G. Beldays, G. Dumyati, M. A. Kainer, R. Lynfield, M. Maloney, L. McAllister-Hollod, J. Nadle, S. M. Ray, D. L. Thompson, L. E. Wilson and S. K. Fridkin, Multistate Point-Prevalence Survey of Health Care-Associated Infections, N. Engl. J. Med., 2014, 370, 1198-1208.
4. P. W. Stone, Economic burden of healthcare-associated infections: an American perspective, Expert Rev. Pharmacoecon. Outcomes Res., 2009, 9, 417-422.
5. A. Marchetti and R. Rossiter, Economic burden of healthcare-associated infection in US acute care hospitals: societal perspective, J. Med. Econ., 2013, 16, 1399-1404.
6. B. Carter, J. T. Collins, F. Barlow-Pay, F. Rickard, E. Bruce, A. Verduri, T. J. Quinn, E. Mitchell, A. Price, A. Vilches-Moraga, M. J. Stechman, R. Short, A. Einarsson, P. Braude, S. Moug, P. K. Myint, J. Hewitt, L. Pearce, K. McCarthy and C. S. Collaborators, Nosocomial COVID-19 infection: examining the risk of mortality. The COPE-Nosocomial Study (COVID in Older PEople), The Journal of hospital infection, 2020, 106, 376-384.
7. L. Rosenstock, 42 CFR Part 84: Respiratory Protective Devices Implications for Tuberculosis Protection, Infect. Control Hosp. Epidemiol., 1995, 16, 529-531.
8. Laboratory performance evaluation of N95 filtering facepiece respirators, 1996, MMWR Morb. Mortal. Wkly. Rep., 1998, 47, 1045-1049.
9. L. Liao, W. Xiao, M. Zhao, X. Yu, H. Wang, Q. Wang, S. Chu and Y. Cui, Can N95 Respirators Be Reused after Disinfection? How Many Times?, ACS Nano, 2020, 14, 6348-6356.
10. G.-H. Zhang, Q.-H. Zhu, L. Zhang, F. Yong, Z. Zhang, S.-L. Wang, Y. Wang, L. He and G.-H. Tao, High-performance particulate matter including nanoscale particle removal by a self-powered air filter, Nat. Commun., 2020, 11, 1653.
11. H. Zhong, Z. Zhu, P. You, J. Lin, C. F. Cheung, V. L. Lu, F. Yan, C.-Y. Chan and G. Li, Plasmonic and Superhydrophobic Self-Decontaminating N95 Respirators, ACS Nano, 2020, 14, 8846-8854.
12. Y. Bai, C. B. Han, C. He, G. Q. Gu, J. H. Nie, J. J. Shao, T. X. Xiao, C. R. Deng and Z. L. Wang, Washable Multilayer Triboelectric Air Filter for Efficient Particulate Matter PM2.5 Removal, Adv. Funct. Mater., 2018, 28, 1706680.
13. A. Charvet, Y. Gonthier, E. Gonze and A. Bernis, Experimental and modelled efficiencies during the filtration of a liquid aerosol with a fibrous medium, Chem. Eng. Sci., 2010, 65, 1875-1886.
14. M. Tebyetekerwa, Z. Xu, S. Yang and S. Ramakrishna, Electrospun Nanofibers-Based Face Masks, Advanced Fiber Materials, 2020, 2, 161-166.
15. Y. Cheng, C. Wang, J. Zhong, S. Lin, Y. Xiao, Q. Zhong, H. Jiang, N. Wu, W. Li, S. Chen, B. Wang, Y. Zhang and J. Zhou, Electrospun polyetherimide electret nonwoven for bi-functional smart face mask, Nano Energy, 2017, 34, 562-569.
16. R. S. Barhate and S. Ramakrishna, Nanofibrous filtering media: Filtration problems and solutions from tiny materials, J. Membr. Sci., 2007, 296, 1-8.
17. S. Ullah, A. Ullah, J. Lee, Y. Jeong, M. Hashmi, C. Zhu, K. I. Joo, H. J. Cha and I. S. Kim, Reusability Comparison of Melt-Blown vs Nanofiber Face Mask Filters for Use in the Coronavirus Pandemic, ACS Applied Nano Materials, 2020, 3, 7231-7241.
18. N. Wang, X. Wang, B. Ding, J. Yu and G. Sun, Tunable fabrication of three-dimensional polyamide-66 nano-fiber/nets for high efficiency fine particulate filtration, J. Mater. Chem., 2012, 22, 1445-1452.
19. Y. Zhang, S. Yuan, X. Feng, H. Li, J. Zhou and B. Wang, Preparation of Nanofibrous Metal-Organic Framework Filters for Efficient Air Pollution Control, J. Am. Chem. Soc., 2016, 138, 5785-5788.
20. Y. Bian, R. Wang, S. Wang, C. Yao, W. Ren, C. Chen and L. Zhang, Metal-organic framework-based nanofiber filters for effective indoor air quality control, Journal of Materials Chemistry A, 2018, 6, 15807-15814.
21. M. Wen, G. Li, H. Liu, J. Chen, T. An and H. Yamashita, Metal-organic framework-based nanomaterials for adsorption and photocatalytic degradation of gaseous pollutants: recent progress and challenges, Environmental Science: Nano, 2019, 6, 1006-1025.
22. S. Feng, X. Li, S. Zhao, Y. Hu, Z. Zhong, W. Xing and H. Wang, Multifunctional metal organic framework and carbon nanotube-modified filter for combined ultrafine dust capture and SO2 dynamic adsorption, Environmental Science: Nano, 2018, 5, 3023-3031.
23. Y. Zhang, X. He, Z. Zhu, W.-N. Wang and S.-C. Chen, Simultaneous removal of VOCs and PM2.5 by metal-organic framework coated electret filter media, J. Membr. Sci., 2021, 618, 118629.
24. Y. Bian, C. Chen, R. Wang, S. Wang, Y. Pan, B. Zhao, C. Chen and L. Zhang, Effective removal of particles down to 15 nm using scalable metal-organic framework-based nanofiber filters, Applied Materials Today, 2020, 20, 100653.
25. R. A. Weinstein, R. Gaynes, J. R. Edwards and N. N. I. S. System, Overview of Nosocomial Infections Caused by Gram-Negative Bacilli, Clin. Infect. Dis., 2005, 41, 848-854.
26. J. D. Siegel, E. Rhinehart, M. Jackson and L. Chiarello, 2007 Guideline for Isolation Precautions: Preventing Transmission of Infectious Agents in Health Care Settings, Am. J. Infect. Control, 2007, 35, S65-S164.
27. L. Zhiqing, C. Yongyun, C. Wenxiang, Y. Mengning, M. Yuanqing, Z. Zhenan, W. Haishan, Z. Jie, D. Kerong, L. Huiwu, L. Fengxiang and Z. Zanjing, Surgical masks as source of bacterial contamination during operative procedures, J Orthop Translat, 2018, 14, 57-62.
28. S. B. Jeong, H. S. Ko, S. C. Seo and J. H. Jung, Evaluation of filtration characteristics and microbial recovery rates of commercial filtering facepiece respirators against airborne bacterial particles, Sci. Total Environ., 2019, 682, 729-736.
29. M. Wu, B. Ma, T. Pan, S. Chen and J. Sun, Silver-Nanoparticle-Colored Cotton Fabrics with Tunable Colors and Durable Antibacterial and Self-Healing Superhydrophobic Properties, Adv. Funct. Mater., 2016, 26, 569-576.
30. J. M. Mazurkow, N. S. Ytizbasi, K. W. Domagala, S. Pfeiffer, D. Kata and T. Graule, Nano-Sized Copper (Oxide) on Alumina Granules for Water Filtration: Effect of Copper Oxidation State on Virus Removal Performance, Environ. Sci. Technol., 2020, 54, 1214-1222.
31. D. Lv, R. Wang, G. Tang, Z. Mou, J. Lei, J. Han, S. De Smedt, R. Xiong and C. Huang, Ecofriendly Electrospun Membranes Loaded with Visible-Light-Responding Nanoparticles for Multifunctional Usages: Highly Efficient Air Filtration, Dye Scavenging, and Bactericidal Activity, ACS Appl. Mater. Interfaces, 2019, 11, 12880-12889.
32. W. Tong, Y. Xiong, S. Duan, X. Ding and F.-J. Xu, Phthalocyanine functionalized poly(glycidyl methacrylate) nano-assemblies for photodynamic inactivation of bacteria, Biomaterials Science, 2019, 7, 1905-1918.
33. R. J. Roberge, E. Bayer, J. B. Powell, A. Coca, M. R. Roberge and S. M. Benson, Effect of Exhaled Moisture on Breathing Resistance of N95 Filtering Facepiece Respirators, The Annals of Occupational Hygiene, 2010, 54, 671-677.
34. A. Haider, S. Kwak, K. C. Gupta and I.-K. Kang, Antibacterial Activity and Cytocompatibility of PLGA/CuO Hybrid Nanofiber Scaffolds Prepared by Electrospinning, Journal of Nanomaterials, 2015, 2015, 832762.
35. Y. Zhang, X. Zhang, Y.-Q. Zhao, X.-Y. Zhang, X. Ding, X. Ding, B. Yu, S. Duan and F.-J. Xu, Self-adaptive antibacterial surfaces with bacterium-triggered antifouling-bactericidal switching properties, Biomaterials Science, 2020, 8, 997-1006.
36. H. Sun, Y. Du, C. Gao, Iftikhar, J. Long, S. Li and L. Shao, Pressure-assisted in-depth hydrophilic tailoring of porous membranes achieving high water permeability, excellent fouling resistance and superior antimicrobial ability, J. Membr. Sci., 2020, 604, 118071.
37. M. Ping, X. Zhang, M. Liu, Z. Wu and Z. Wang, Surface modification of polyvinylidene fluoride membrane by atom-transfer radical-polymerization of quaternary ammonium compound for mitigating biofouling, J. Membr. Sci., 2019, 570-571, 286-293.
38. Z. K. Zander, P. Chen, Y.-H. Hsu, N. Z. Dreger, L. Savariau, W. C. McRoy, A. E. Cerchiari, S. D. Chambers, H. A. Barton and M. L. Becker, Post-fabrication QAC-functionalized thermoplastic polyurethane for contact-killing catheter applications, Biomaterials, 2018, 178, 339-350.
39. W. W. Wilson, M. M. Wade, S. C. Holman and F. R. Champlin, Status of methods for assessing bacterial cell surface charge properties based on zeta potential measurements, J. Microbiol. Methods, 2001, 43, 153-164.
M. C. Jennings, K. P. C. Minbiole and W. M. Wuest, Quaternary Ammonium Compounds: An Antimicrobial Mainstay and Platform for Innovation to Address Bacterial Resistance, ACS Infectious Diseases, 2015, 1, 288-303.
41. G. Gozzelino, C. Lisanti and S. Beneventi, Quaternary ammonium monomers for UV crosslinked antibacterial surfaces, Colloids Surf. Physicochem. Eng. Aspects, 2013, 430, 21-28.
42. Y. Jiao, L.-n. Niu, S. Ma, J. Li, F. R. Tay and J.-h. Chen, Quaternary ammonium-based biomedical materials: State-of-the-art, toxicological aspects and antimicrobial resistance, Prog. Polym. Sci., 2017, 71, 53-90.
43. M. H. Chua, W. Cheng, S. S. Goh, J. Kong, B. Li, J. Y. C. Lim, L. Mao, S. Wang, K. Xue, L. Yang, E. Ye, K. Zhang, W. C. D. Cheong, B. H. Tan, Z. Li, B. H. Tan and X. J. Loh, Face Masks in the New COVID-19 Normal: Materials, Testing, and Perspectives, Research, 2020, 2020, 7286735.
44. M. Tang, D. Thompson, S.-C. Chen, Y. Liang and D. Y. H. Pui, Evaluation of different discharging methods on HVAC electret filter media, Build. Environ., 2018, 141, 206-214.
45. K. Xie, Q. Fu, Y. He, J. Kim, S. J. Goh, E. Nam, G. G. Qiao and P. A. Webley, Synthesis of well dispersed polymer grafted metal-organic framework nanoparticles, Chem. Commun., 2015, 51, 15566-15569.
46. H. Sun, B. Tang and P. Wu, Development of Hybrid Ultrafiltration Membranes with Improved Water Separation Properties Using Modified Superhydrophilic Metal-Organic Framework Nanoparticles, ACS Appl. Mater. Interfaces, 2017, 9, 21473-21484.
47. J. Xue, T. Wu, Y. Dai and Y. Xia, Electrospinning and Electrospun Nanofibers: Methods, Materials, and Applications, Chem. Rev., 2019, 119, 5298-5415.
48. EN, ISO 21083-1:2018, Test method to measure the efficiency of air filtration media against spherical nanomaterials—Part 1: Size range from 20 nm to 500 nm, 2018.
49. C.-Y. Tien, J.-P. Chen, S. Li, Z. Li, Y.-M. Zheng, A. S. Peng, F. Zhou, C.-J. Tsai and S.-C. Chen, Experimental and theoretical analysis of loading characteristics of different electret media with various properties toward the design of ideal depth filtration for nanoparticles and fine particles, Sep. Purif. Technol., 2020, 233, 116002.
50. NIOSH, Approval of Respiratory Protective Devices, Code of Federal Regulations Title 42, Part 84. NIOSH, Cincinnati, OH, USA., 1995, 16, 529-531.
51. W. Hao, G. Xu and Y. Wang, Factors influencing the filtration performance of homemade face masks, J. Occup. Environ. Hyg., 2021, 18, 128-138.
52. S. Saebo, L. Farnell, N. V. Riggs and L. Radom, Molecular structure, rotational constants, and vibrational frequencies for ethynamine (NH2-C.tplbond.CH): a possible interstellar molecule, J. Am. Chem. Soc., 1984, 106, 5047-5051.
53. X. Tang, J. Wei, Z. Kong, H. Zhang and J. Tian, Introduction of amino and rGO into PP nonwoven surface for removal of gaseous aromatic pollutants and particulate matter from air, Appl. Surf. Sci., 2020, 511, 145631.
54. C. Greve, N. K. Preketes, R. Costard, B. Koeppe, H. Fidder, E. T. J. Nibbering, F. Temps, S. Mukamel and T. Elsaesser, N—H Stretching Modes of Adenosine Monomer in Solution Studied by Ultrafast Nonlinear Infrared Spectroscopy and Ab Initio Calculations, The Journal of Physical Chemistry A, 2012, 116, 7636-7644.
55. A. Schaate, P. Roy, A. Godt, J. Lippke, F. Waltz, M. Wiebcke and P. Behrens, Modulated

Synthesis of Zr-Based Metal—Organic Frameworks: From Nano to Single Crystals, Chemistry—A European Journal, 2011, 17, 6643-6651.
56. Q. Xiao, Y. Liang, F. Zhu, S. Lu and S. Huang, Microwave-assisted one-pot synthesis of highly luminescent N-doped carbon dots for cellular imaging and multi-ion probing, Microchim. Acta, 2017, 184, 2429-2438.
57. J.-W. Xu, Y. Wang, Y.-F. Yang, X.-Y. Ye, K. Yao, J. Ji and Z.-K. Xu, Effects of quaternization on the morphological stability and antibacterial activity of electrospun poly(DMAEMA-co-AMA) nanofibers, Colloids Surf. B. Biointerfaces, 2015, 133, 148-155.
58. S. V. Fridrikh, J. H. Yu, M. P. Brenner and G. C. Rutledge, Controlling the Fiber Diameter during Electrospinning, Phys. Rev. Lett., 2003, 90, 144502.
59. N. K. Adam, The Physics and Chemistry of Surfaces, Oxford University Press, 1941.
60. X. Wang, B. Ding, J. Yu and J. Yang, Large-scale fabrication of two-dimensional spider-web-like gelatin nano-nets via electro-netting, Colloids Surf. B. Biointerfaces, 2011, 86, 345-352.
61. S. Lowell, J. E. Shields, M. A. Thomas and M. Thommes, Characterization of porous solids and powders: surface area, pore size and density, Springer Science & Business Media, 2012.
62. D.-Q. Chang, S.-C. Chen and D. Y. H. Pui, Capture of Sub-500 nm Particles Using Residential Electret HVAC Filter Media-Experiments and Modeling, Aerosol and Air Quality Research, 2017, 16, 3349-3357.
63. S.-C. Chen, J. Wang, Y. K. Bahk, H. Fissan and D. Y. H. Pui, Carbon Nanotube Penetration Through Fiberglass and Electret Respirator Filter and Nuclepore Filter Media: Experiments and Models, Aerosol Sci. Technol., 2014, 48, 997-1008.
64. W. C. Hinds and W. C. Hinds, Aerosol Technology: Properties, Behavior, and Measurement of Airborne Particles, Wiley, 1999.
65. T.-H. Kao, S.-K. Su, C.-I. Su, A.-W. Lee and J.-K. Chen, Polyacrylonitrile microscaffolds assembled from mesh structures of aligned electrospun nanofibers as high-efficiency particulate air filters, Aerosol Sci. Technol., 2016, 50, 615-625.
66. H. Wan, N. Wang, J. Yang, Y. Si, K. Chen, B. Ding, G. Sun, M. El-Newehy, S. S. Al-Deyab and J. Yu, Hierarchically structured polysulfone/titania fibrous membranes with enhanced air filtration performance, J. Colloid Interface Sci., 2014, 417, 18-26.
67. Z. Wang, Y. Zhang, X. Y. D. Ma, J. Ang, Z. Zeng, B. F. Ng, M. P. Wan, S.-C. Wong and X. Lu, Polymer/MOF-derived multilayer fibrous membranes for moisture-wicking and efficient capturing both fine and ultrafine airborne particles, Sep. Purif. Technol., 2020, 235, 116183.
68. X. Dai, X. Li and X. Wang, Morphology controlled porous polylactic acid)/zeolitic imidazolate framework-8 fibrous membranes with superior PM2.5 capture capacity, Chem. Eng. J., 2018, 338, 82-91.
69. C. Liu, P.-C. Hsu, H.-W. Lee, M. Ye, G. Zheng, N. Liu, W. Li and Y. Cui, Transparent air filter for high-efficiency PM2.5 capture, Nat. Commun., 2015, 6, 6205.
70. G. Mainelis, Bioaerosol sampling: Classical approaches, advances, and perspectives, Aerosol Sci. Technol., 2020, 54, 496-519.
71. C. W. Haig, W. G. Mackay, J. T. Walker and C. Williams, Bioaerosol sampling: sampling mechanisms, bioefficiency and field studies, The Journal of hospital infection, 2016, 93, 242-255.
72. S. Rengasamy, R. Shaffer, B. Williams and S. Smit, A comparison of facemask and respirator filtration test methods, J. Occup. Environ. Hyg., 2017, 14, 92-103.
73. J. Li, A. Leavey, Y. Wang, C. O'Neil, M. A. Wallace, C.-A. D. Burnham, A. C. M. Boon, H. Babcock and P. Biswas, Comparing the performance of 3 bioaerosol samplers for influenza virus, J. Aerosol Sci, 2018, 115, 133-145.
74. S. Wessels and H. Ingmer, Modes of action of three disinfectant active substances: A review, Regul. Toxicol. Pharm., 2013, 67, 456-467.
75. R. Kaur and S. Liu, Antibacterial surface design—Contact kill, Prog. Surf. Sci., 2016, 91, 136-153.
76. R. Krieger, Hayes' handbook of pesticide toxicology, Academic press, 2010.
77. G. Wickham, An investigation into the relative resistances of common bacterial pathogens to quaternary ammonium cation disinfectants, Bioscience Horizons: The International Journal of Student Research, 2017, 10.
78. E. Koufakis, T. Manouras, S. H. Anastasiadis and M. Vamvakaki, Film Properties and Antimicrobial Efficacy of Quaternized PDMAEMA Brushes: Short vs Long Alkyl Chain Length, Langmuir, 2020, 36, 3482-3493.
79. R. Kügler, O. Bouloussa and F. Rondelez, Evidence of a charge-density threshold for optimum efficiency of biocidal cationic surfaces, Microbiology, 2005, 151, 1341-1348.
80. M. Mercury, International programme on chemical safety, 1990, 118.
81. J. Zhou, Z. Hu, F. Zabihi, Z. Chen and M. Zhu, Progress and Perspective of Antiviral Protective Material, Advanced Fiber Materials, 2020, 2, 123-139.
82. Burtch, N. C., H. Jasuja, and K. S. Walton, Water Stability and Adsorption in Metal-Organic Frameworks. Chemical Reviews, 2014. 114(20): p. 10575-10612.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A filter, comprising
at least one layer of polymer nanofibers; and
antibacterial particles positioned on or within the at least one layer of polymer nanofibers, wherein the antibacterial particles comprise a quaternary ammonium compound (QAC) grafted onto a surface of a metal-organic framework.

2. The filter of claim 1, wherein the at least one layer of polymer nanofibers comprises polyacrylonitrile (PAN) nanofibers.

3. The filter of claim 1, wherein the QAC is poly[2-(dimethyl decyl ammonium) ethyl methacrylate] (PQDMAEMA).

4. The filter of claim 1, wherein the metal-organic framework is a zirconium-based metal-organic framework.

5. The filter of claim 1, wherein the metal-organic framework is a titanium-based metal-organic framework.

6. The filter of claim 1, further comprising graphitic carbon nitride (g-C₃N₄) arranged on a surface of the metal-organic framework.

7. The filter of claim 1, wherein the antibacterial particles constitute 55-65 wt % of the filter.

8. The filter of claim 1, wherein the antibacterial particles have a larger diameter than the polymer nanofibers.

9. The filter of claim 1, wherein the antibacterial particles have an average diameter of 200-250 nm.

10. The filter of claim 1, wherein the polymer nanofibers have an average diameter of 100-150 nm.

11. The filter of claim 1, wherein the antibacterial particles are positioned on a surface of the polymer nanofibers.

12. A face mask wearable by a subject comprising the filter of claim 1.

13. A method for decontaminating a fluid, comprising bringing the fluid in contact with the filter of claim 1.

14. The method of claim 13, wherein the fluid is or comprises air.

15. The method of claim 13, wherein the fluid is or comprises water.

16. The method of claim 13, wherein the filter is incorporated within a face mask wearable by a subject.

17. The method of claim 13, wherein the filter is incorporated within a heating, ventilation, and air conditioning (HVAC) system.

18. A method of manufacturing the filter of claim 1, comprising electrospinning a polymer solution comprising the antibacterial particles onto a collector.

19. The method of claim 18, wherein the electrospinning step is performed at a temperature of 45-55° C.

20. The method of claim 18, wherein the electrospinning step is performed at a relative humidity of 5-15%.

21. The method of claim 18, wherein the electro spinning step is performed at a voltage of 15-20 kV.

22. The method of claim 18, wherein the polymer solution contains polyacrylonitrile (PAN).

23. The method of claim 18, wherein the polymer solution contains 55-65 wt % antibacterial particles.
